(19) United States
(12) Patent Application Publication
(10) Pub. No.: US 2002/0124071 A1
(43) Pub. Date: Sep. 5, 2002

(54) Method and apparatus for customizing multimedia channel maps

(76) Inventors: Andrew M. Proehl, San Francisco, CA (US); Matthew S. Chang, San Diego, CA (US); Aditya Krishnan, San Diego, CA (US); David K.L. Yang, San Jose, CA (US); Fred J. Zustak, Poway, CA (US); Peter Rae Shintani, San Diego, CA (US); Mark Kenneth Eyer, San Diego, CA (US); Nicholas Colsey, Del Mar, CAU (US); Brant L. Candelore, Escondido, CA (US); Dayan Ivy Golden, San Diego, CA (US)

Correspondence Address: MILLER PATENT SERVICES, 2500 DOCKERY LANE, RALEIGH, NC, 27606, US

(21) Appl. No.: 09/798,814

(22) Filed: Mar. 2, 2001

(51) Int. Cl. G06F 15/173

(52) U.S. Cl. 709/223; 709/238

(57) ABSTRACT

A method and apparatus are provided whereby a user of a set-top box may customize a user interface so as to simplify the interaction between the user and the set-top box. The user interface includes a channel map, which may be customized by the user. The channel map may include a subset of broadcast television channels together with virtual channels, such as alternate video sources, networked devices, web sites and other media supported by the set-top box. The user may customize the channel map, through interaction with user interface of the set-top box, to reflect his or her preferences and may select between virtual channels in the channel map using a simple input device, such as a remote control device.

### FIELD OF THE INVENTION

This invention relates generally to user interfaces for multimedia networks.

### BACKGROUND OF THE INVENTION

Consumer entertainment devices, communication devices and computers are commonly combined to form a multimedia network. At the heart of the network is a device termed an interactive set-top box, which provides a network of connections between consumer devices and one or more remote service providers. The set-top box can be used by a user to access and view information via an increasing number of media, including audio, video, television, web pages, digital cameras, etc.

A set-top box operates as an information network, connecting one or more of a plurality of inputs to one or more of a plurality of outputs. Several different classes of inputs can be present, including:

Fixed link, multiplexed inputs, such as terrestrial, satellite or cable television broadcast links;

Communications links to circuit switched networks, such as the public telephone network;

Communications links to packet switched networks, such as the Internet; and

Links to local network devices, such as video recorders, DVD players, video cameras, compact disk players, etc.

Within each class of inputs, there is a plurality of individual inputs for the user to select. A set-top box is configured to select between any of the individual inputs in any of the classes of inputs, decode the signals and route them to the appropriate output device, such as a television display or loudspeaker. The sequence of operations required to make the selection is different for each class of inputs. For example, to select a television channel, the tuner must be adjusted, the appropriate decoder selected and the signal routed to an audio visual display such as a television. To select a web page, a web browser must be loaded, a connection made with a remote ISP host and data packets sent via the Internet to a remote web server. The returning data packets must be decoded, routed to a graphics processor and then sent to an audio visual display.

The sequence of operations for each class is fixed. Accordingly, it is not necessary for the user to participate in each step. This is commonly the case when a personal computer is used as an information network. For example, when a user uses a computer mouse to select a document, the application for displaying that document is displayed. If the document is a web page, it is not necessary for him of her to explicitly load and run a web browser, since the system is programmed to know that this action is required. Similarly, if the document is stored on a remote device, such as network server or a digital camera, the appropriate actions will be taken to retrieve and display the document. The actions involve configuring inputs and output and running software to translate the document for display. This simplifies the operation of the computer. On a personal computer, running an operating system such as Windows 98, for example, the user may create “shortcuts” to facilitate the initiation of frequently used operations. The “shortcuts” appear as screen icons that, when selected by a computer mouse, cause a particular operation to occur. In this way, the computer user interface may be customized by the user. However, the number of icons that can be stored on a single screen is limited. For example, if an icon were used for each favorite web address and each frequently called telephone number, there would be insufficient space on the screen. Further, it would be difficult to find a particular icon if too many were displayed.

In contrast, a television user interface is not customizable. Previously there has been little need for customization because there were a limited number of actions that could be taken. An infrared or wireless remote control provides a very simple interface to allow the user to change channels. However, in spite of its simplicity, the remote control can be used to select between a moderately large number of channels.

When used as a web browser, a set-top box set has to potential to link to any of millions of web sites. Clearly, it is not practical to scroll through a complete list as is done with prior television channel selectors.

Consequently, there is a need for a user interface of a set-top box to have the simplicity of a television channel selector and yet provide the capacity for a user to select between a very large number of available channels.

### SUMMARY OF THE INVENTION

It is accordingly an object of the invention to provide a method and apparatus whereby a user of a set-top box may customize a user interface between the user and the set-top box so as to simplify the interaction between the user and the set-top box.

According to the present invention, the set-top box includes a channel map, which may be customized by the user. In contrast to current television channel maps, which are fixed and support only broadcast television channels, the channel map of the present invention may include a subset of broadcast television channels together with virtual channels such as alternate video sources, networked devices, web sites and other media supported by the set-top box. The user may customize the channel map, through interaction with the set-top box, to reflect his or her preferences. The user may select between virtual channels in the channel map using a simple input device, such as a remote control. In this way, a simplified, and therefore improved, user interface is provided.

### BRIEF DESCRIPTION OF THE DRAWINGS

The novel features believed characteristic of the invention are set forth in the claims. The invention itself, however, as well as the preferred mode of use, and further objects and advantages thereof, will best be understood by reference to the following detailed description of an illustrative embodiment when read in conjunction with the accompanying drawing(s), wherein:

FIG. 1 is a diagrammatic representation of a television channel map, in accordance with the prior art.

FIG. 2 is a block diagram of an exemplary multimedia network, in accordance with the current invention.

FIG. 3 is a block diagram of an exemplary interactive set-top box, in accordance with the current invention.

FIG. 4 is a diagrammatic representation of a virtual channel map, in accordance with the current invention.

FIG. 5 is a flow chart for an exemplary mode of operation of a virtual channel ring selector, in accordance with an embodiment of the present invention.

FIG. 6 is a flow chart for an exemplary mode of operation of a virtual channel selector, in accordance with an embodiment of the present invention.

FIG. 7 is a diagrammatic representation of another exemplary virtual channel map, in accordance with an embodiment the present invention.

FIG. 8 is a home page screen shot illustrating available gateways corresponding to different channel maps via hubs, in accordance with the present invention.

FIG. 9 is a screen shot, navigated to from the home page of FIG. 8, illustrating a sub-hub that can itself be a gateway to a channel ring.

### DESCRIPTION OF THE INVENTION

While this invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described. In the description below, like reference numerals are used to describe the same, similar or corresponding parts in the several Views of the drawings.

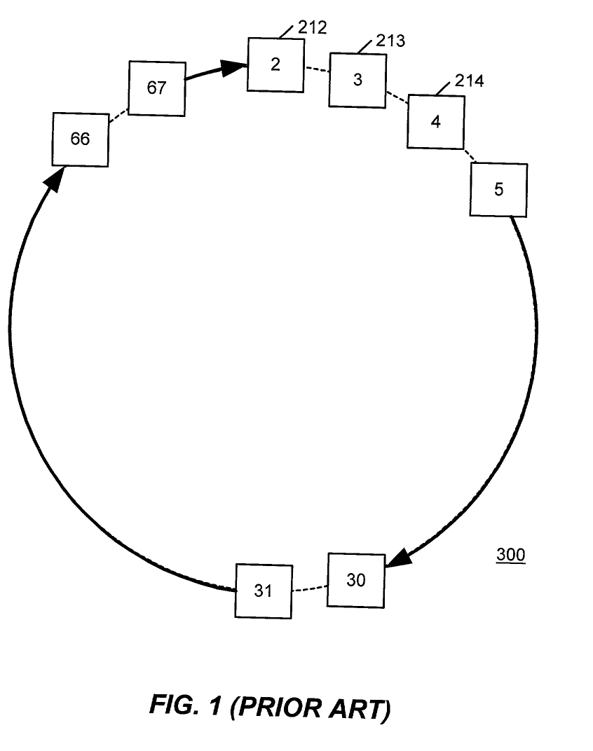

Channel maps are known in the art. For example, FIG. 1 shows a fixed channel map 300 utilized in television systems of the prior art. Channel numbers, such as those depicted in blocks 212, 213 and 214, are arranged sequentially in a loop or ring. The viewer may proceed in a clockwise direction around the ring by operating the “channel-up” or “Ch+” button on a remote control, or in a counter-clockwise direction by operating the “channel-down” or “Ch−” button. Alternatively, the viewer may select a particular channel by entering its number from a numeric keypad on a remote control. This provides a very simple user interface, which is familiar to millions of television viewers worldwide. The channel numbers correspond to particular channel numbers in a multiplexed television signal. Selection of a particular channel number causes the television tuner to pass only that channel.

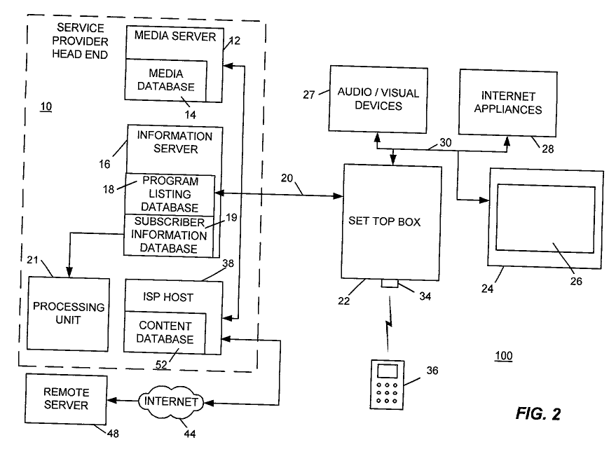

Referring to FIG. 2, a block diagram for an exemplary interactive cable or satellite television (TV) system 100 is shown. The system 100 includes, at a head end of the service provider 10, a media server 12 for providing, on demand, movies and other programming obtained from a media database 14. The media server 12 might also provide additional content such as interviews with the actors, games, advertisements, available merchandise, associated Web pages, interactive games and other related content. The system 100 also includes an electronic programming guide (EPG) server 16 and a program listing database 18 for generating an EPG. Set-top box 22 can generally provide for bidirectional communication over a transmission medium 20 in the case of a cable STB 22. In other embodiments, bidirectional communication can be effected using asymmetrical communication techniques possibly using dual communication media—one for the uplink and one for the downlink. In any event, the STB 22 can have its own Universal Resource Locator (URL) or IP address or other unique identifier assigned thereto to provide for addressability by the head end and users of the Internet.

The media server 12 and EPG server 16 are operatively coupled by transmission medium 20 to a set-top box (STB) 22. The transmission medium 20 may include, for example, a conventional coaxial cable network, a fiber optic cable network, telephone system, twisted pair, a satellite communication system, a radio frequency (RF) system, a microwave system, other wireless systems, a combination of wired and wireless systems or any of a variety of known electronic transmission mediums. In the case of a cable television network, transmission medium 20 is commonly realized at the subscriber's premises as a coaxial cable that is connected to a suitable cable connector at the rear panel of the STB 22. In the case of a Direct Satellite System (DSS), the STB 22 is often referred to as an Integrated Receiver Decoder (IRD). In the case of a DSS system, the transmission medium is a satellite transmission at an appropriate microwave band. Such transmissions are typically received by a satellite dish antenna with an integral Low Noise Block (LNB) that serves as a down-converter to convert the signal to a lower frequency for processing by the STB 22.

The exemplary system 100 further includes a TV 24, such as a digital television, having a display 26 for displaying programming, an EPG, etc. The STB 22 may be coupled to the TV 24 and various other audio/visual devices 27 (such as audio systems, Personal Video Recorders (PVRs), Video Tape Recorders (VTRs), Video Cassette Recorders (VCRs) and the like), storage devices (e.g., hard disc drives) and Internet Appliances 28 (such as email devices, home appliances, storage devices, network devices, and other Internet Enabled Appliances) by an appropriate interface 30, which can be any suitable analog or digital interface. In one embodiment, interface 30 conforms to an interface standard such as the Institute of Electrical and Electronics Engineers (IEEE) 1394 standard, but could also be wholly or partially supported by a DVI interface (Digital Visual Interface—Digital Display Working Group, www.ddwg.org) or other suitable interface.

The STB 22 may include a central processing unit (CPU) such as a microprocessor and memory such as Random Access Memory (RAM), Read Only Memory (ROM), flash memory, mass storage such as a hard disc drive, floppy disc drive, optical disc drive or may accommodate other electronic storage media, etc. Such memory and storage media is suitable for storing data as well as instructions for programmed processes for execution on the CPU, as will be discussed later. Information and programs stored on the electronic storage media or memory may also be transported over any suitable transmission medium such as that illustrated as 20. STB 22 may include circuitry suitable for audio decoding and processing, the decoding of video data compressed in accordance with a compression standard such as the Motion Pictures Experts Group (MPEG) standard and other processing to form a controller or central hub. Alternatively, components of the STB 22 may be incorporated into the TV 24 itself, thus eliminating the STB 22. Further, a computer having a tuner device and modem may be equivalently substituted for the TV 24 and STB 22.

By way of example, the STB 22 may be coupled to devices such as a personal computer, video cassette recorder, camcorder, digital camera, personal digital assistant and other audio/visual or Internet related devices. In addition, a data transport architecture may be utilized to enable interoperability among devices on a network regardless of the manufacturer of the device if manufacturers agree to adhere to an industry standard. The STB 22 runs an operating system suitable for a home network system The STB 22 includes an infrared (IR) receiver 34 for receiving IR signals from an input device such as remote control 36. Alternatively, it is noted that many other control communication methods may be utilized besides IR, such as wired or wireless radio frequency, etc. In addition, it can be readily appreciated that the input device 36 may be any device suitable for controlling the STB 22 such as a remote control, personal digital assistant, laptop computer, keyboard or computer mouse. In addition, an input device in the form of a control panel located on the TV 24 or the STB 22 can be provided.

The STB 22 may also be coupled to an independent service provider (ISP) host 38 by a suitable connection including dial-up connections, DSL (Digital Subscriber Line) or the same transmission medium 20 described above (e.g., using a cable modem) to, thus, provide access to services and content from the ISP and the Internet. The ISP host 38 provides various content to the user that is obtained from a content database 42. STB 22 may also be used as an Internet access device to obtain information and content from remote servers such as remote server 48 via the Internet 44 using host 38 operating as an Internet portal, for example. In certain satellite STB environments, the data can be downloaded at very high speed from a satellite link, with asymmetrical upload speed from the set-top box provided via a dial-up or DSL connection.

While the arrangement illustrated in FIG. 2 shows a plurality of servers and databases depicted as independent devices, any one or more of the servers can operate as server software residing on a single computer. Moreover, although not explicitly illustrated, the servers may operate in a coordinated manner under centralized or distributed control to provide multiple services as a Multiple Service Operator (MSO) in a known manner. Additionally, the services provided by the servers shown in FIG. 2 may actually reside in other locations, but from the perspective of the user of STB 22, the service provider 10 serves as a portal to the services shown. Those skilled in the art will appreciate that the illustration of FIG. 2 represents a simplified depiction of a cable system configuration shown simply as service provider 10. The actual configuration of the service provider's equipment is more likely to follow a configuration defined by the CableLabs OpenCable™ specification. The simplified illustration shown is intended to simplify the discussion of the service provider 10's operation without unnecessarily burdening the discussion with architectural details that will be evident to those skilled in the art. Many of those details can be found in the publicly available CableLabs OpenCable™ specification or in the text “OpenCable Architecture (Fundamentals)” by Michael Adams, Cisco Press, November 1999.

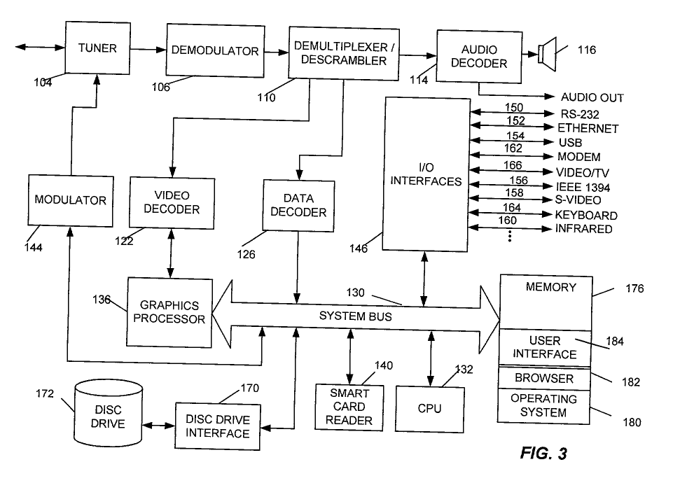

Referring now to FIG. 3, an exemplary system configuration for a digital set-top box 22 is illustrated. In this exemplary set-top box, the transmission medium 20, such as a coaxial cable, is coupled by a suitable interface through a diplexer 102 to a tuner 104. Tuner 104 may, for example, include a broadcast in-band tuner for receiving content, an out-of-band (OOB) tuner for receiving data transmissions. A return path through diplexer 102 provides an OOB return path for outbound data (destined for example for the head end). A separate tuner (not shown) may be provided to receive conventional RF broadcast television channels. Modulated information formatted, for example, as MPEG-2 information is then demodulated at a demodulator 106. The demodulated information at the output of demodulator 106 is provided to a demultiplexer and descrambler circuit 110 where the information is separated into discrete channels of programming. The programming is divided into packets, each packet bearing an identifier called a Packet ID (PID) that identifies the packet as containing a particular type of data (e.g., audio, video, data). The demodulator and descrambler circuit 110 also descrambles scrambled information in accordance with a decryption algorithm to prevent unauthorized access to programming content, for example.

Audio packets from the demultiplexer 110 (those identified with an audio PID) are decrypted and forwarded to an audio decoder 114 where they may be converted to analog audio to drive a speaker system (e.g., stereo or home theater multiple channel audio systems) or other audio system 116 (e.g., stereo or home theater multiple channel amplifier and speaker systems) or may simply provide decoded audio out at 118. Video packets from the demultiplexer 110 (those identified with a video PID) are decrypted and forwarded to a video decoder 122. In a similar manner, data packets from the demultiplexer 110 (those identified with a data PID) are decrypted and forwarded to a data decoder 126.

Decoded data packets from data decoder 126 are sent to the set-top box's computer system via the system bus 130. A central processing unit (CPU) 132 can thus access the decoded data from data decoder 126 via the system bus 130. Video data decoded by video decoder 122 is passed to a graphics processor 136, which is a computer optimized to processes graphics information rapidly. Graphics processor 136 is particularly useful in processing graphics intensive data associated with Internet browsing, gaming and multimedia applications. It should be noted, however, that the function of graphics processor 136 may be unnecessary in some set-top box designs having lower capabilities, and the function of the graphics processor 136 may be handled by the CPU 132 in some applications where the decoded video is passed directly from the demultiplexer 110 to a video encoder. Graphics processor 136 is also coupled to the system bus 130 and operates under the control of CPU 132.

Many set-top boxes such as STB 22 may incorporate a smart card reader 140 for communicating with a so called “smart card,” often serving as a Conditional Access Module (CAM). The CAM typically includes a central processor unit (CPU) of its own along with associated RAM and ROM memory. Smart card reader 140 is used to couple the system bus of STB 22 to the smart card serving as a CAM (not shown). Such smart card based CAMs are conventionally utilized for authentication of the user and authentication of transactions carried out by the user as well as authorization of services and storage of authorized cryptography keys. For example, the CAM can be used to provide the key for decoding incoming cryptographic data for content that the CAM determines the user is authorized to receive.

STB 22 can operate in a bidirectional communication mode so that data and other information can be transmitted not only from the system's head end to the end user, or from a service provider to the end user of the STB 22, but also, from the end user upstream using an out-of-band channel. In one embodiment, such data passes through the system bus 130 to a modulator 144 through the diplexer 102 and out through the transmission medium 20. This capability is used to provide a mechanism for the STB 22 and/or its user to send information to the head end (e.g., service requests or changes, registration information, etc.) as well as to provide fast outbound communication with the Internet or other services provided at the head end to the end user.

Set-top box 22 may include any of a plurality of I/O (Input/Output) interfaces represented by I/O interfaces 146 that permit interconnection of I/O devices to the set-top box 22. By way of example, and not limitation, a serial RS-232 port 150 can be provided to enable interconnection to any suitable serial device supported by the STB 22's internal software. Similarly, communication with appropriately compatible devices can be provided via an Ethernet port 152, a USB (Universal Serial Bus) port 154, an IEEE 1394 (so-called firewire™ or i-LINK™) or IEEE 1394 port 156, S-video port 158 or infrared port 160. Such interfaces can be utilized to interconnect the STB 22 with any of a variety of accessory devices such as storage devices, audio/visual devices 26, gaming devices (not shown), Internet Appliances 28, etc.

I/O interfaces 146 can include a modem (be it dial-up, cable, DSL or other technology modem) having a modem port 162 to facilitate high speed or alternative access to the Internet or other data communication functions. In one preferred embodiment, modem port 162 is that of a DOCSIS (Data Over Cable System Interface Specification) cable modem to facilitate high speed network access over a cable system, and port 162 is appropriately coupled to the transmission medium 20 embodied as a coaxial cable. Thus, the STB 22 can carry out bidirectional communication via the DOCSIS cable modem with the STB 22 being identified by a unique IP address. The DOCSIS specification is publicly available. Of course, it is envisioned that the modem can be built into the set-top box.

A PS/2 or other keyboard/mouse/joystick interface such as 164 can be provided to permit ease of data entry to the STB 22. Such inputs provide the user with the ability to easily enter data and/or navigate using pointing devices. Pointing devices such as a mouse or joystick may be used in gaming applications.

Of course, STB 22 also may incorporate basic video outputs 166 that can be used for direct connection to a television set such as 24 instead of (or in addition to) an IEEE 1394 connection such as that illustrated as 30. In one embodiment, Video output 166 can provide composite video formatted as NTSC (National Television System Committee) video.

The infrared port 160 can be embodied as an infrared receiver 34 as illustrated in FIG. 2, to receive commands from an infrared remote control 36, infrared keyboard or other infrared control device. Although not explicitly shown, front panel controls may be used in some embodiments to directly control the operation of the STB 22 through a front panel control interface as one of interfaces 146. Selected interfaces such as those described above and others can be provided in STB 22 in various combinations as required or desired.

STB 22 will more commonly, as time goes on, include a disc drive interface 170 and disc drive mass storage 172 for user storage of content and data as well as providing storage of programs operating on CPU 132. STB 22 may also include floppy disc drives, CD ROM drives, CD RW drives, DVD drives, etc. CPU 132, in order to operate as a computer, is coupled through the system bus 130 (or through a multiple bus architecture) to memory 176. Memory 178 may include a combination any suitable memory technology including Random Access Memory (RAM), Read Only Memory (ROM), Flash memory, Electrically Erasable Programmable Read Only Memory (EEPROM), etc.

While the above exemplary system including STB 22 is illustrative of the basic components of a digital set-top box suitable for use with the present invention, the architecture shown should not be considered limiting since many variations of the hardware configuration are possible without departing from the present invention. The present invention could, for example, also be implemented in more advanced architectures such as that disclosed in U.S. patent application Ser. No. 09/473,625, filed Dec. 29, 1999, Docket No. SONY-50N3508 entitled “Improved Internet Set-Top Box Having and In-Band Tuner and Cable Modem” to Jun Maruo and Atsushi Kagami. This application describes a set-top box using a multiple bus architecture with a high level of encryption between components for added security. This application is hereby incorporated by reference as though disclosed fully herein.

In general, during operation of the STB 22, an appropriate operating system 180 is loaded into, or is permanently stored in, active memory along with the appropriate drivers for communication with the various interfaces. In other embodiments, other operating systems such as Microsoft Corporation's Windows CE™ could be used without departing from the present invention. Along with the operating system and associated drivers, the STB 22 usually operates using browser software 182 and user interface software 184 in active memory or browser software may permanently reside in ROM, EEPROM or Flash memory, for example. The browser software 182 may operate as the mechanism for viewing not only web pages on the Internet, and can also serve as the mechanism for viewing an Electronic Program Guide (EPG) formatted as an HTML document.

STB software architectures vary depending upon the operating system. However, in general, all such architectures generally include, at the lowest layer, various hardware interface layers. Next is an operating system layer as previously described. The software architectures of modern STB have generally evolved to include a next layer referred to as “middleware.” Such middleware permits applications to run on multiple platforms with little regard for the actual operating system in place. Middleware standards are still evolving at this writing, but are commonly based upon Javascript and HTML (hypertext Markup Language) virtual machines. At the top layer is the application layer where user applications and the like reside, e.g., browsing, email, EPG, Video On Demand (VOD), rich multimedia applications, pay per view, etc. The current invention can be utilized with any suitable set-top box software and hardware architecture.

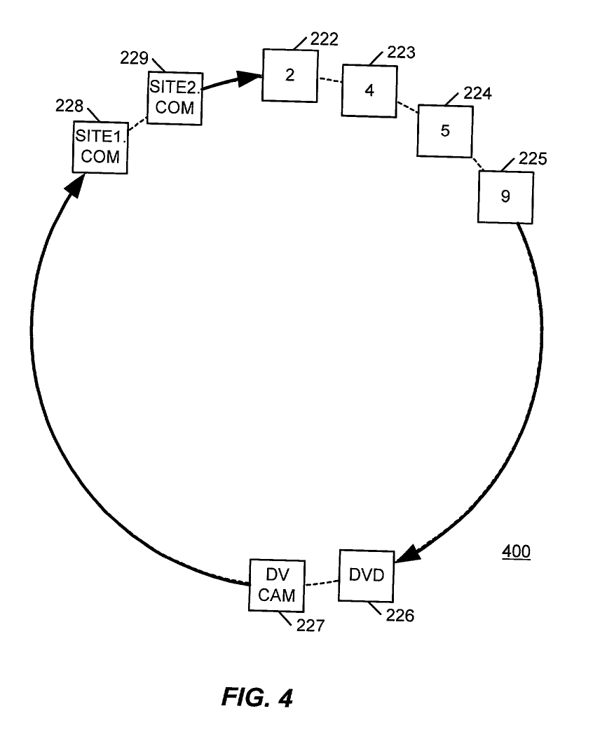

In the preferred embodiment, the user interface of the present invention is configured as an application in the application layer and may interact with one or more other applications. The user interface incorporates a virtual channel map. FIG. 4 shows an exemplary virtual channel map 400 according to the present invention. The virtual channel map may include actual television channels, such as those depicted in blocks 222, 223, 224 and 225, as well as virtual channels. For example, if the channel represented by block 226 is selected, the set-top box will cause the digital video disc (DVD) player to be activated and its output routed to the appropriate audio-visual display unit. If the channel represented by block 227 is selected, the set-top box will cause the output from a digital video (DV) camera to be routed to the appropriate audio-visual display. If the channel represented by block 228 or 229 is selected, the set-top box will cause a web browser to be activated, connected to a remote Independent Service Provider (ISP) and a data packet to be transmitted, via the Internet, to the remote server with web address site1.com or site2.com, respectively. The user of the set-top box may switch between these virtual channels using a remote control device.

Each virtual channel may be assigned a number, so that the user may also select virtual channels by operation of a numeric keypad. A “menu” button may be used to display a list of virtual channels and the associated numbers on a visual display unit.

The virtual channel map may be modified by the user's interaction with the set-top box. Virtual channels may be added or removed and the order of presentation of the channels may be modified.

The channel map may also be configured as a plurality of connected rings. For example, one ring may provide access to a selection of television channels, while a second ring may provide access to a selection of Internet web sites for receiving streamed video or audio, or for on-line shopping or banking services. Another ring may provide access to a selection of home network devices, such as video camera, digital audio players, video recorders, digital cameras and web cameras. Another ring may provide for a list of telephone numbers. In one embodiment, a particular ring may be selected by operation of associated keys on the remote control. In a further embodiment, a “menu” button may be used to cause the set-top box to display a menu of rings on the audio visual display. The user may then select a ring by using operating the “channel-up” or “channel-down” buttons to highlighted the desired ring and then operating a “select” button. The “select” button may be the same button as the “menu” button. Alternatively, the viewer may select a particular ring by entering its number from a numeric keypad on the remote control.

When multiple users use the same set-top box, the connected rings may be assigned one or more per user.

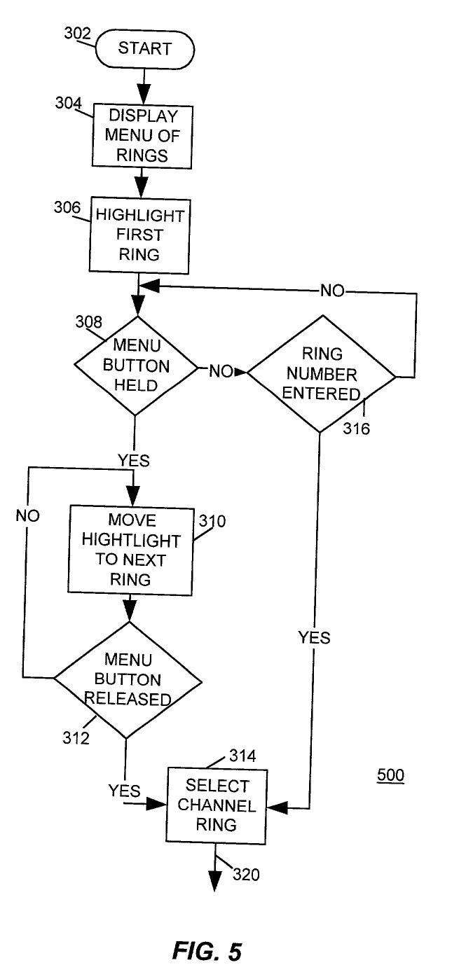

A flow chart for an exemplary method 500 for selecting between virtual channel rings is depicted in FIG. 5. Following the start of operation of the set-top box at block 302, a menu of available virtual channel rings is displayed on the audio visual display unit at block 304. One ring in the menu is highlighted at block 306. To highlight a different virtual channel ring, the user may hold down the “menu” button on a remote control 36. At decision block 308 a check is made to determine if the “menu” button is held down. If it is, as depicted by the affirmative branch from decision block 308, the next virtual channel ring in the menu is highlighted at block 310. At decision block 312 a check is made to determine if the “menu” button has been released. If it has been released, as depicted by the affirmative branch from decision block 312, the highlighted virtual channel ring is selected at block 314 and flow 320 continues to the virtual channel selector described below. If the “menu” button has not been released, as depicted by the negative branch from decision block 312, the flow returns to block 310 and the next virtual channel ring is highlighted. If the depressed button is not the “menu” button, as depicted by the negative branch from decision block 308, a check is made to determine if a specific virtual ring number has been entered via the numeric keypad on the remote control. If a valid virtual ring number has been entered, as depicted by the affirmative branch from decision block 316, the entered virtual channel ring number is selected at block 314 and flow 320 continues to the virtual channel selector described below. If the entered number is not a valid virtual channel ring number, as depicted by the negative branch from decision block 316, flow continues to block 308 and waits for the next button to be pressed.

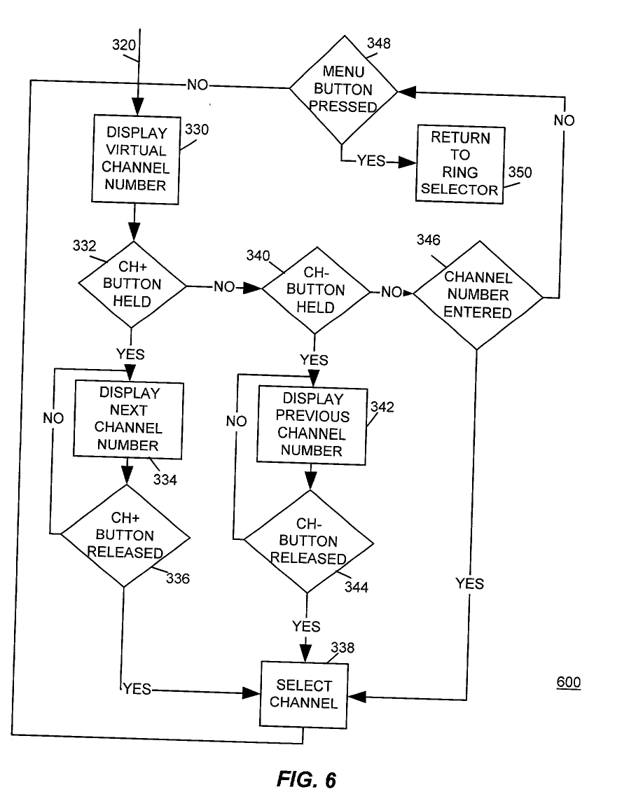

A flow chart for an exemplary method 600 for selecting between virtual channels is depicted in FIG. 6. Flow 320 is passed from the virtual channel ring selection method described above. The process begins by displaying a first virtual channel identifier at block 330. The identifier may be a web address, a station ID, a device name or other mnemonic. The identifier may be displayed as a overlay at the edge of the current screen display. At decision block 332 a check is made to determine if the “Ch+” button is held down. If it is, as depicted by the affirmative branch from decision block 332, the next virtual channel identifier is displayed at block 334. At decision block 336 a check is made to determine if the “Ch+” button has been released. If it has been released, as depicted by the affirmative branch from decision block 336, the channel corresponding to the currently displayed virtual channel identifier is selected at block 338 and flow returns to block 330. If the “Ch+” has not been released, as depicted by the negative branch from decision block 336, the flow returns to block 334 and the next virtual channel identifier is displayed. If the depressed button is not the “Ch+” button, as depicted by the negative branch from decision block 332, a check is made to determine if the “Ch−” button is depressed. If it is, as depicted by the affirmative branch from decision block 340, the previous virtual channel identifier is displayed at block 342. At decision block 344 a check is made to determine if the “Ch−” button has been released. If it has been released, as depicted by the affirmative branch from decision block 344, the channel corresponding to the currently displayed virtual channel identifier is selected at block 338 and flow returns to block 330. If the “Ch−” has not been released, as depicted by the negative branch from decision block 344, the flow returns to block 342 and the previous virtual channel identifier is displayed.

If the depressed button is neither the “Ch+” button nor the “Ch−” button, as depicted by the negative branch from decision block 340, a check is made at decision block 346 to determine if a specific virtual channel number has been entered via the numeric keypad on the remote control. If a valid virtual ring number has been entered, as depicted by the affirmative branch from decision block 346, the entered channel number is selected at block 338 and flow returns to block 330. If the entered number is not a valid virtual channel number, as depicted by the negative branch from decision block 346, a check is made at decision block 348 to determine if the “menu” button has been pressed. If it has, as depicted by the affirmative branch from decision block 348, flow returns to the start 302 of the virtual channel ring selector 500, as depicted by block 350. If the “menu” button has not been pressed, as depicted by the negative branch from decision block 348, flow continues to block 330 and waits for the next button to be pressed.

If no button is pressed for a predetermined period of time, the channel identifier display may be turned off.

In one embodiment of the present invention, a graphic user interface is provided whereby a user may select and customize a virtual channel map. The user may be prompted to enter an identifier for the map. The map may be displayed as a linear list of virtual channels or as a ring of virtual channels, as depicted in FIG. 4. Through interaction with the graphical user interface, the user may delete or add virtual channels. The user may edit virtual channels either by entering an identifier, such as a web site, or by browsing and selecting from a list of available channels. The list of available channel maps may also be customized in a similar manner.

A particular channel map may be stored in a computer file, whereby it may be passed to users of other set-top boxes, via email, for example. Also, by this method, third parties may distribute customized channel maps, to allow for easy navigation around one or more web sites, as an example.

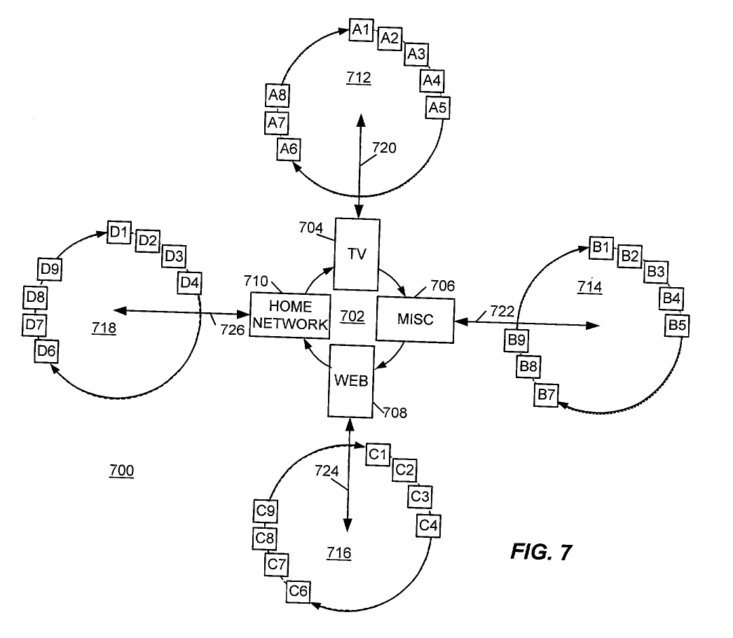

An exemplary virtual channel map 700 comprising four virtual channel rings is shown in FIG. 7. Virtual channel ring selector 702 has four listed items 704, 706, 708 and 710 corresponding to the four virtual channel rings 712, 714, 716 and 718 respectively. In this example, virtual channel ring 712 lists television channels A1 . . . A8, virtual channel ring 714 lists miscellaneous virtual channels B1 . . . B9, virtual channel ring 716 lists web site addresses C1 . . . C9 and virtual channel ring 718 lists home network devices D1 . . . D9, such as DVD players, DV recorders, web cams, etc. Selection of a listed item in virtual channel ring selector 702 will cause operation to flow to a corresponding virtual channel ring, as depicted by links 720, 722, 724 and 726. The user may then select one of the virtual channels from the virtual channel ring for viewing as described above. The user may also select to return to the virtual channel rings selector, as also described above.

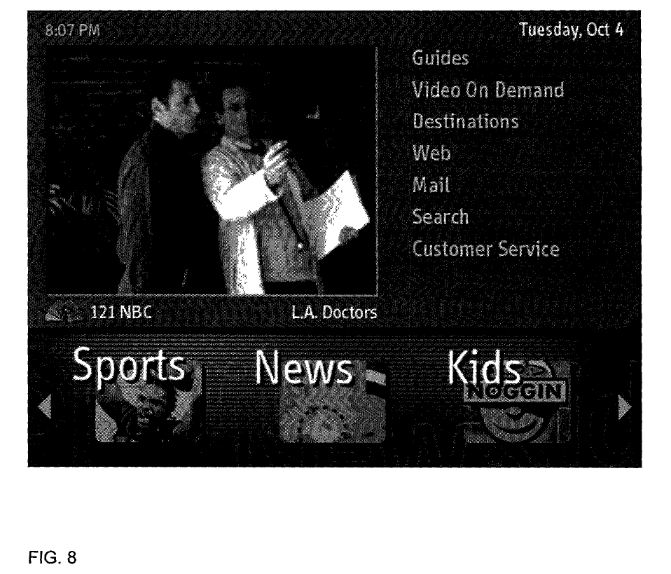

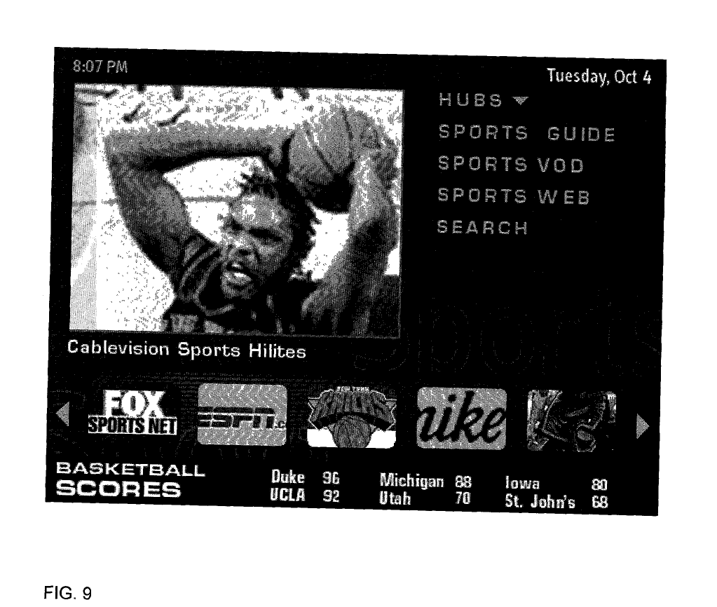

FIGS. 8 and 9 illustrate, through the exemplary use of television screen shots, the use of gateways into various channel maps. In FIG. 8, a home page screen shot provides a user with gateway access to available hubs, labeled as Sports, News, Kids, etc. in this example, that are themselves gateways to other channel rings. FIG. 9 is a screen shot, navigated to from the home page of FIG. 8, illustrating a sub-hub that can itself be a gateway to a channel ring. Selection of the “Sports” hub, for instance, provides the user with a gateway to a sports channel ring, in effect a sub-channel ring including options for the user to select from Fox, ESPN, New York Nicks, Nike, etc.

While the invention has been particularly shown and described with reference to a preferred embodiment, it will be understood by those skilled in the art that various changes in form and detail may be made therein without departing from the spirit and scope of the invention.

What is claimed is:

1. A method for controlling the operation of a multimedia network having a plurality of media inputs and at least one output to an audio visual display, said system comprising:
assigning a channel map relating one or more of the plurality of media inputs to a corresponding virtual channel;
determining a selected virtual channel in response to one or more user inputs from a user of the multimedia network; and
configuring the multimedia network to process a multimedia input assigned to said selected virtual channel and to display it on said audio visual display.

2. A method as in claim 1, wherein said channel map comprises a sequential ring.

3. A method as in claim 2, further comprising:
receiving a specified user input of the one or more user inputs; and
determining a new selected virtual channel,
wherein said new selected virtual channel is a next virtual channel in said sequential ring.

4. A method as in claim 2, further comprising:
receiving a specified user input of the one or more user inputs; and
determining a new selected virtual channel;
wherein said new selected virtual channel is a previous virtual channel in said sequential ring.

5. A method as in claim 2, further comprising:
assigning a virtual channel identifier to each virtual channel.

6. A method as in claim 5, wherein said virtual channel identifier is a virtual channel number.

7. A method as in claim 5, further comprising:
receiving the virtual channel identifier from said one or more user inputs;
determining said selected virtual channel that corresponds to said virtual channel identifier received from said one or more user inputs;

8. A method as in claim 1, wherein said channel map is arranged as a plurality of interconnected sequential rings, each interconnected sequential ring of the plurality of interconnected sequential rings having a corresponding ring identifier.

9. A method as in claim 8, further comprising:
assigning a channel ring map relating one or more of said plurality of interconnected sequential rings to said corresponding ring identifiers.

10. A method as in claim 9, further comprising:
receiving a specified user input of the one or more user inputs; and
selecting a virtual channel ring of the channel ring map according to said specified user input.

11. A method as in claim 1, wherein said channel map is stored in an electronic data file.

12. A method as in claim 11, wherein said assigning channel map comprises:
determining a graphical representation of said channel map according to said electronic data file;
displaying a graphical user interface, which includes the graphical representation of said channel map, on the audio visual display; and
updating said electronic data file according to interaction of a user with said graphical user interface.

13. A method as in claim 1, wherein said one or more user inputs is received from a remote control device.

14. An interactive set-top box providing a network of connections between a plurality of input media and at least one output medium, said interactive set-top box comprising:
a plurality of input ports configured to receive the plurality of input media;
at least one output port configured to transmit the at least one output medium to a display;
a system bus configurable to operatively couple said plurality of input ports to said at least one output port;
a memory element operatively coupled to said system bus and configured to store a user interface program and data; and
a processor element operatively coupled to said system bus and configured to process said user interface program and data;
wherein said data includes a representation of a channel map relating one or more of said plurality of input media to a virtual channel.

15. A system as in claim 14, further comprising:
a user input port operatively coupled to said system bus and configured to receive one or more user inputs from a user input device;
wherein said user interface program is configured to respond to said one or more user inputs.

16. A system as in claim 15, wherein said user interface program is operable to configure said channel map in response to said one or more user inputs.

17. A system as in claim 15, wherein said user interface program is operable to determine a selected virtual channel in response to said one or more user inputs.

18. A system as in claim 17, wherein said interactive set-top box is configured to connect an input port, of said plurality of input ports, corresponding to said selected virtual channel to said at least one output port.

19. A system as in claim 18, wherein said channel map comprises a sequential ring.

20. A system as in claim 19, wherein, in response to a specified user input, a new selected virtual channel is selected to be a next virtual channel in said sequential ring.

21. A system as in claim 19, wherein, in response to a specified user input, a new selected virtual channel is selected to be a previous virtual channel in said sequential ring.

22. A system as in claim 15, wherein said user input port is an infrared receiver port.

23. A system as in claim 15, wherein said user input device is a wireless remote control.
